(19) United States
(12) Patent Application Publication
(10) Pub. No.: US 2006/0157661 A1
(43) Pub. Date: Jul. 20, 2006

(54) Integrated attachment feature

(76) Inventors: Dan Baljet, Rochester Hills, MI (US); James R. Henson, Mount Sterling, KY (US)

Correspondence Address: CARLSON, GASKEY & OLDS, P.C., 400 WEST MAPLE ROAD, SUITE 350, BIRMINGHAM, MI, 48009, US

(21) Appl. No.: 11/299,576

(22) Filed: Dec. 12, 2005

Related U.S. Application Data
(63) Continuation-in-part of application No. PCT/US04/16601, filed on May 26, 2004.
(60) Provisional application No. 60/478,378, filed on Jun. 13, 2003.

(51) Int. Cl. F16L 29/00

(52) U.S. Cl. 251/148

(57) ABSTRACT

A vehicle coolant system (10) includes a service valve (26) through which coolant is added to or removed from the coolant system (10). The service valve (26) includes a first and second port (32, 34), and a rubber hose (24, 28) is fitted over both the first and second ports (32, 34). A sealing ring (42) having an integrated barbed attachment feature (44) is overmolded on the joint of the rubber hoses (24, 28) and the respective ports (32, 34). The integrated barbed attachment feature (44) is inserted into an aperture (62) in a structural element (30) of the vehicle. As the integrated barbed attachment feature (44) passes through the aperture (62), the plurality of barbs (54) flex. After passing through the aperture (62), the plurality of barbs (54) return to the original position, securing the service valve (26) to the structural element (30). Alternately, the sealing ring (142) includes an integrated projection (170) having an aperture (162), and the structural element (130) includes a barbed attachment feature (144) including a plurality of barbs (154).

### REFERENCE TO RELATED APPLICATIONS

This application is a continuation-in-part of PCT Application Number PCT/US2004/016601 filed on May 26, 2004, which claims priority to United States Provisional Application No. 60/478,378 filed on Jun. 13, 2003.

### BACKGROUND OF THE INVENTION

The present invention relates generally to a sealing ring that secures a hose to a port of a service valve in a vehicle coolant system. More specifically, the present invention relates to a sealing ring including an integrated attachment feature that attaches the service valve to a structural element of a vehicle.

In a vehicle coolant system, a coolant absorbs heat from an engine and rejects the heat to a fluid medium in a radiator. The coolant circulates through these components and through a system of hoses. The coolant system includes a service valve including two ports that are each connected to a hose and a third port through which the coolant can be added to or removed from the coolant system. A plastic ring is molded around the joint of the hoses and the ports to provide a seal.

The service valve is secured to a structural element of the vehicle to facilitate access to the service valve and to prevent movement of the hoses. The service valve is commonly attached near the passenger compartment and under the instrument panel. A plastic tie cable having a barbed attachment feature is wrapped around the plastic ring. The cable tie can be retained on the plastic ring by an adhesive to provide additional strength.

The barbed attachment feature is inserted into an aperture in the structural element to secure the service valve to the structural element. As the barbed attachment feature is pushed through the aperture, the barbs flex, allowing the barbed attachment feature to pass through the aperture. Once inserted, the barbs return to the original position, securing the service valve to the structural element.

There are several drawbacks to the tie ring including the barbed attachment feature of the prior art. For one, it is both time consuming and costly to manually assemble the cable ties to the service valve. Additionally, the adhesive can leak onto other vehicle components.

Therefore, the present invention provides a simplified attachment of a service valve to a structural element of a vehicle by integrating an attachment feature into a sealing ring molded around a joint of a hose and a port of the service valve.

### SUMMARY OF THE INVENTION

A vehicle coolant system includes an engine, a radiator, and a service valve including a first port, a second port and a third port. Coolant flows through the system. The coolant enters the service valve through a hose fitted on the first port and exits the service valve through a hose fitted on the second port. The coolant is added to or removed from the coolant system through the third port of the service valve.

A sealing ring having an integrated barbed attachment feature is overmolded on the joint of the hoses and the respective ports. In one example, the sealing ring and the barbed attachment feature are made of Nylon 6/6. Once the sealing ring and the barbed attachment feature are molded over the joints, the Nylon 6/6 cools and shrinks to exert a tightening force on the joints.

The barbed attachment feature includes a central boss and a plurality of barbs extending circumferentially around the central boss. Each of the plurality of barbs also includes a slit which allows the barb to flex.

The barbed attachment feature is inserted into an aperture in a structural element of a vehicle to attach the service valve to the structural element. As the barbed attachment feature is inserted into the aperture, the plurality of barbs flex towards the central boss, allowing the barbed attachment feature to pass through the aperture. After the barbed attachment feature passes through the aperture, the plurality of barbs return to the original position, securing the service valve to the structural element of the vehicle. The plurality of barbs flex in one direction to allow the barbed attachment feature to be inserted into the aperture, but are rigid in the opposing direction to prevent withdrawal of the barbed attachment feature from the aperture.

Alternatively, the sealing ring includes an integrated projection having an aperture, and the structural element includes a barbed attachment feature including a plurality of barbs extending circumferentially around a central boss. The barbed attachment feature of the structural element is inserted into the aperture in the integrated projection of the sealing ring. As the barbed attachment feature of the structural element is inserted into the aperture of the integrated projection of the sealing ring, the plurality of barbs flex towards the central boss, allowing the barbed attachment feature to pass through the aperture. After the barbed attachment feature passes through the aperture, the plurality of barbs return to the original position, securing the service valve to the structural element of the vehicle.

In another embodiment, a water pump of a coolant system includes an integrated barbed attachment feature. The water pump circulates water through a circuit to cool an engine. A molded ring is molded around a portion of the water pump and includes the barbed attachment feature. The integrated barbed attachment feature in inserted into an aperture in sheet metal of the vehicle to secure the water pump to the vehicle.

These and other features of the present invention will be best understood from the following specification and drawings.

### BRIEF DESCRIPTION OF THE DRAWINGS

FIG. 1 schematically illustrates a coolant system of a vehicle;

FIG. 2 schematically illustrates a perspective view of a service valve;

FIG. 3 schematically illustrates a perspective view of hoses attached to the service valve of FIG. 2;

FIG. 4 schematically illustrates a perspective view of a first embodiment of the sealing ring of the present invention molded on the joint of the hoses and the service valve and including an integrated barbed attachment feature;

FIG. 5 schematically illustrates a side view of a tool molding cavity located around the joint of a hose and a port of the service valve;

FIG. 6 schematically illustrates a top view of one of the plurality of barbs of the barbed attachment feature;

FIG. 7 schematically illustrates a perspective view of a second embodiment of the sealing ring of the present invention;

FIG. 8 schematically illustrates another coolant system of the vehicle; and

FIG. 9 schematically illustrates an enlarged view of a barbed attachment feature of FIG. 8.

### DETAILED DESCRIPTION OF THE PREFERRED EMBODIMENT

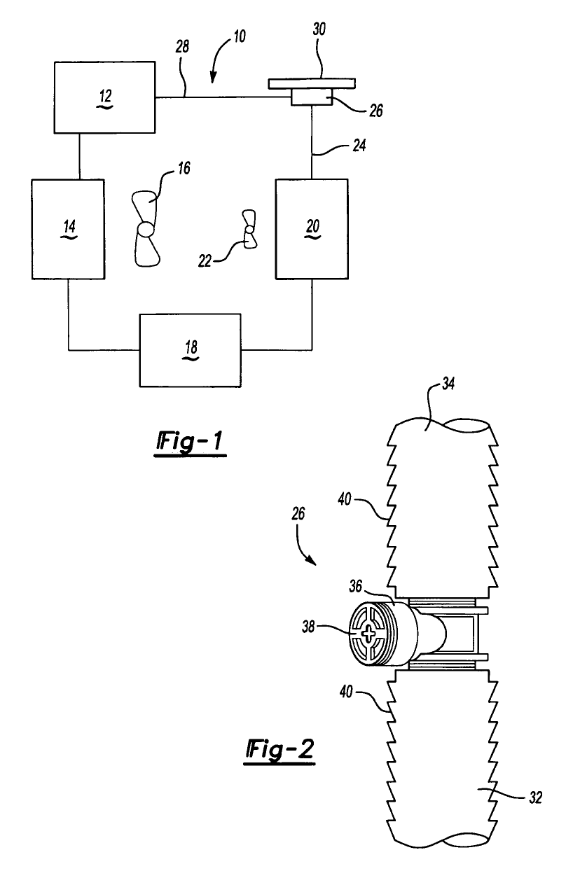

FIG. 1 schematically illustrates a coolant system 10 of a vehicle. A pump 12 propels coolant into a radiator 14. A radiator fan 16 blows air over the radiator 14, and the coolant rejects heat to the surrounding air and is cooled. The coolant then flows into an engine 18 and absorbs heat from the engine 18. After exiting the engine 18, the coolant flows through a heater core 20. If a vehicle heater is activated, a heater fan 22 blows air over the heater core 20, providing heat to a passenger compartment of the vehicle and further cooling the coolant. The coolant flows through a rubber hose 24 and into a service valve 26. Coolant is added to or removed from the coolant system 10 through the service valve 26. The coolant then flows out of the service valve 26 through a rubber hose 28 and returns to the pump 12, completing the cycle. As explained below, the service valve 26 is attached to a structural element 30 of a vehicle, such as sheet metal located near the passenger compartment and under an instrument panel of the vehicle.

FIG. 2 illustrates a perspective view of the service valve 26. The service valve 26 includes a first port 32 in fluid communication with the heater core 20, a second port 34 in fluid communication with the pump 12, and a third port 36 through which the coolant can be added to or removed from the coolant system 10. A cover 38 removably covers the third port 36. When coolant is to be added to or removed from the coolant system 10, the cover 38 is removed from the third port 36 to provide access to the coolant system 10. The first port 32 and the second port 34 also include contours 40 extending towards the third port 36.

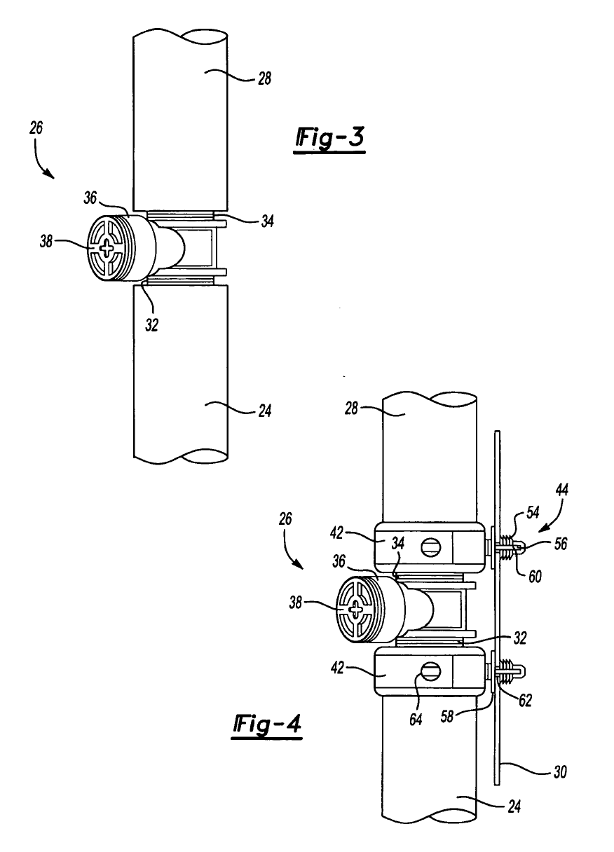

As shown in FIG. 3, the first port 32 is fitted with the rubber hose 24 that receives coolant from the heater core 20, and the second port 34 is fitted with the rubber hose 28 that provides coolant to the pump 12. The contours 40 retain the rubber hoses 24 and 28 on the respective ports 32 and 34 of the service valve 26.

As shown in FIG. 4, after the rubber hoses 24 and 28 are fitted over the respective ports 32 and 34 of the service valve 26, a sealing ring 42 having an integrated barbed attachment feature 44 is overmolded on the joint of each of the rubber hoses 24 and 28 and the respective port 32 and 34. The term “integrated” means that the barbed attachment feature 44 is formed in one piece with the sealing ring 42. Preferably, the sealing ring 42 and the integrated barbed attachment feature 44 are formed by an injection molding process. Preferably, the sealing ring 42 and the integrated barbed attachment feature 44 are made of Nylon 6/6. Nylon 6/6 provides suitable mechanical and physical properties. However, other materials or thermoplastics can be used to form the sealing ring 42 and the integrated barbed attachment feature 44, and one skilled in the art would know what materials to employ.

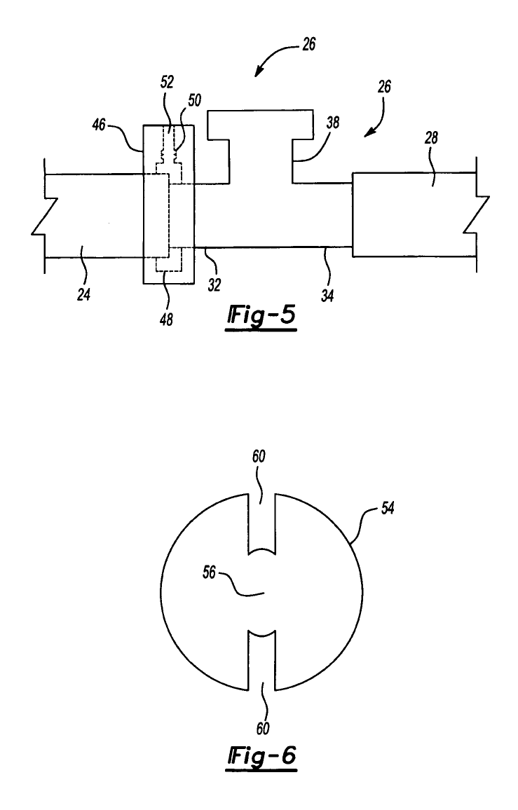

As shown in FIG. 5, when forming the sealing ring 42 and the integrated barbed attachment feature 44 of the present invention, the service valve 26 is inserted into a tooling mold cavity 46. The tooling mold cavity 46 includes a cavity 48 in the shape of the sealing ring 42 and a cavity 50 in the shape of the integrated barbed attachment feature 44. Liquid Nylon 6/6 is injected through an aperture 52 in the tooling mold cavity 46, and the liquid Nylon 6/6 flows into the cavities 48 and 50. As the Nylon 6/6 cools, it shrinks and crystallizes to exert a tightening force on the joint of the rubber hoses 24 and 28 and the respective ports 32 and 34 to create a tight seal. When the Nylon 6/6 cools, the sealing ring 42 and the integrated barbed attachment feature 44 are integrated into one piece. Therefore, the adhesive of the prior art is not needed to secure the integrated barbed attachment feature 44 to the sealing ring 42.

Returning to FIG. 4, each integrated barbed attachment feature 44 includes a plurality of barbs 54 extending circumferentially around a central boss 56 and a stop ring 58 also extending circumferentially around the central boss 56. Generally, the integrated barbed attachment feature 44 resembles the shape of a “pine tree,” and the plurality of barbs 54 are analogous to branches. The plurality of barbs 54 extend toward the sealing ring 42. As shown in FIG. 6, each of the plurality of barbs 54 includes two slits 60 which allows the plurality of barbs 54 to flex when the integrated barbed attachment feature 44 is inserted into an aperture 62 in the structural element 30. Although an integrated barbed attachment feature 44 has been illustrated and described, it is to be understood that any type of attachment feature can be integrated with the sealing ring 42 to secure the service valve 26 to the structural element 30.

After the sealing ring 42 is molded over the joint of the rubber hoses 24 and 28 and the respective ports 32 and 34, the service valve 26 is attached to the structural element 30. The integrated barbed attachment feature 44 is inserted into the aperture 62 in the structural element 30. The diameter of the aperture 62 is slightly smaller than the diameter of the integrated barbed attachment feature 44. As the integrated barbed attachment feature 44 is inserted into the aperture 62, the slits 60 allow the plurality of barbs 54 to flex towards the central boss 56 to a flexed position, allowing the integrated barbed attachment feature 44 to pass through the aperture 62. After passing through the aperture 62, the plurality of barbs 54 return to the original position. The plurality of barbs 54 are rigid, and therefore the integrated barbed attachment feature 44 cannot be removed the aperture 62. The ability of the plurality of barbs 54 to flex in one direction while being rigid in the opposing direction allows the integrated barbed attachment feature 44 to be attached to the structural element 30 while preventing the integrated barbed attachment feature 44 from being removed from the structural element 30.

The stop ring 58 halts the passage of the integrated barbed attachment feature 44 into the aperture 62 of the structural element 30. After the integrated barbed attachment feature 44 is inserted into the aperture 62, the structural element 30 is located between the plurality of barbs 54 and the stop ring 58 of the integrated barbed attachment feature 44.

The sealing ring 42 further includes an opening 64. When the sealing ring 42 is to be removed from the service valve 26, a cutting tool can be inserted into the opening 64 to cut the sealing ring 42. The sealing ring 42 can then be removed from the joint, and the service valve 26 can be then removed from the structural element 30 of the vehicle.

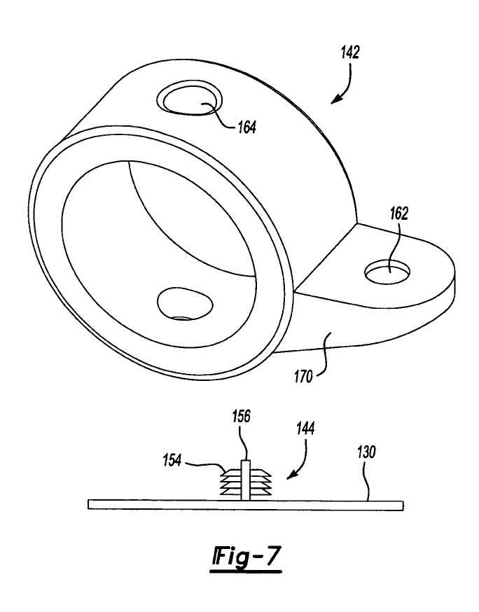

FIG. 7 schematically illustrates an alternate embodiment of the sealing ring 142 of the present invention. The sealing ring 142 includes an integrated projection 170 having an aperture 162. In one example, the sealing ring 142 and the integrated projection 170 are made of Nylon 6/6 and formed by same the process described above. However, other materials can be used, and one skilled in the art would know what materials to employ to form the sealing ring 142 and the integrated projection 170.

The structural element 130 includes a barbed attachment feature 144 including a plurality of barbs 154 extending circumferentially around a central boss 156. Generally, the barbed attachment feature 144 resembles the shape of a “pine tree,” and the plurality of barbs 154 are analogous to branches. The plurality of barbs 154 extend towards the structural element 130. Each of the plurality of barbs 154 includes two slits (not shown) that allow the plurality of barbs 154 to flex when the barbed attachment feature 144 is inserted into the aperture 162 in the integrated projection 170. Although a barbed attachment feature 144 has been illustrated and described, it is to be understood that the structural element 130 can include any type of attachment feature to secure the service valve 126 to the structural element 130.

When the service valve 126 is to be attached to the structural element 130, the barbed attachment feature 144 is inserted into the aperture 162 of the integrated projection 170 of the sealing ring 142. The diameter of the aperture 162 is slightly smaller than the diameter of the barbed attachment feature 144. As the barbed attachment feature 144 is inserted through the aperture 162, the plurality of barbs 154 flex towards the central boss 156 to a flexed position, allowing the barbed attachment feature 144 to advance through the aperture 162 of the integrated projection 170. After passing through the aperture 162, the plurality of barbs 154 return to the original position. The plurality of barbs 154 are rigid, and therefore the barbed attachment feature 144 resists being pulled back through the aperture 162 in the integrated projection 170.

After inserting the barbed attachment feature 144 in the aperture 162 of the integrated projection 170 of the sealing ring 142, the integrated projection 170 is located between the structural element 130 and the barbed attachment feature 144. The ability of the plurality of barbs 154 to flex in one direction while being rigid in the opposing direction allows the barbed attachment feature 144 to be attached to the integrated projection 170 while preventing the barbed attachment feature 144 from being removed from the aperture 162 in the integrated projection 170.

The sealing ring 142 further includes an opening 164. When the sealing ring 142 is to be removed from the service valve 126, a cutting tool can be inserted into the opening 164 to cut the sealing ring 142. The sealing ring 142 can then be removed from the joint, and the service valve 126 can be removed from the structural element 130 of the vehicle.

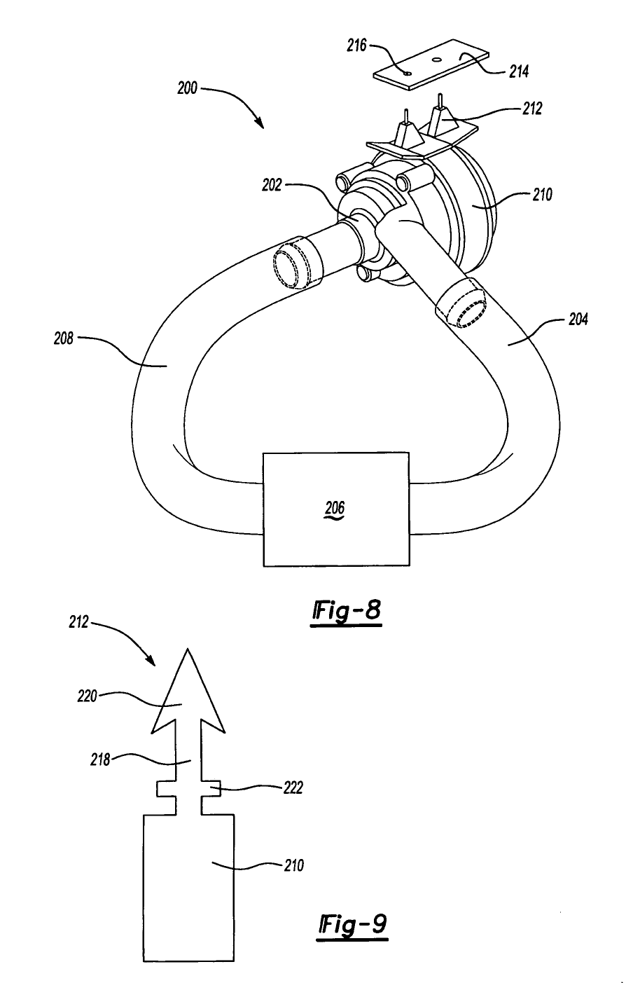

FIG. 8 shows an alternate coolant system 200. The coolant system 200 includes a water pump 202 that pumps water through a conduit 204. The water flows though an engine 206 and accepts heat from the engine 206. The water then flows through another conduit 208 and re-enters the water pump 202, completing the cycle.

A ring 210 including an integral barbed attachment feature 212 is molded around a portion of the water pump 202. The ring 210 and the barbed attachment feature 212 are made of a thermoplastic, such as Nylon 6/6.

The ring 210 and the barbed attachment feature 212 are formed as described above.

To form the ring 210, a rubber sleeve is positioned over the water pump 202. The ring 210 is then overmolded over the rubber sleeve. The ring 210 is formed in the method described above.

The water pump 210 is attached to a structural element 214 of a vehicle, such as piece of sheet metal. The barbed attachment feature 212 is inserted into an aperture 216 in the structural element 214 to secure the water pump 210 to the structural element 214.

As shown in FIG. 9, each barbed attachment feature 212 includes a plurality of barbs 220 extending circumferentially around a central boss 218 and a stop ring 222 also extending circumferentially around the central boss 218. Generally, the integrated barbed attachment feature 212 resembles the shape of a “pine tree,” and the plurality of barbs 220 are analogous to branches. The plurality of barbs 220 extend toward the ring 210.

After the ring 210 is molded over the water pump 202, the water pump 202 is attached to the structural element 214. The barbed attachment feature 212 is inserted into the aperture 216 in the structural element 214. The diameter of the aperture 216 is slightly smaller than the diameter of the integrated barbed attachment feature 212. As the integrated barbed attachment feature 212 is inserted into the aperture 216, the plurality of barbs 220 flex to a flexed position, allowing the barbed attachment feature 212 to pass through the aperture 216. After passing through the aperture 216, the plurality of barbs 220 return to an original position. The plurality of barbs 220 are rigid, and the barbed attachment feature 212 cannot be removed the aperture 216.

The stop ring 222 halts the passage of the barbed attachment feature 212 into the aperture 216 of the structural element 214. After the barbed attachment feature 212 is inserted into the aperture 216, the structural element 214 is located between the plurality of barbs 220 and the stop ring 222 of the barbed attachment feature 212.

Alternately, the sealing ring 201 includes an aperture and the structural element 214 includes a barbed attachment feature.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. An attachment apparatus comprising:
a first component; and
a molded ring molded around the first component, wherein the molded ring includes an integrated attachment feature that attaches the first component to a second component.

2. The apparatus as recited in claim 1 wherein the first component is a service valve including a first tubular portion and a second tubular portion, the apparatus further including:
a first hose connected to the first tubular portion at a first joint, and
a second hose connected to the second tubular portion at a second joint, wherein the molded ring is a sealing ring molded circumferentially around at least one of the first joint and the second joint.

3. The apparatus as recited in claim 2 wherein the service valve further comprises a port, and coolant is added to a coolant system and removed from the coolant system through the port.

4. The apparatus as recited in claim 2 wherein the first tubular portion and the second tubular portion each include a plurality of contours.

5. The apparatus as recited in claim 2 wherein the molded ring and the integrated attachment feature are integrated into one piece.

6. The apparatus as recited in claim 2 wherein the molded ring and the integrated attachment feature are both made of Nylon 6/6.

7. The apparatus as recited in claim 2 wherein the molded ring further includes a hole, and a cutting tool is insertable in the hole to remove the molded ring from the service valve.

8. The apparatus as recited in claim 2 wherein the molded ring comprises a first molded ring and a second molded ring, and the first molded ring is molded circumferentially around the first joint and the second molded ring is molded circumferentially around the second joint.

9. The apparatus as recited in claim 2 wherein the integrated attachment feature is a barbed attachment feature comprising a central boss and a plurality of barbs extending circumferentially around the central boss.

10. The apparatus as recited in claim 9 wherein each of the plurality of barbs further include a slit.

11. The apparatus as recited in claim 9 wherein the barbed attachment feature further comprises a stop ring extending circumferentially around the central boss.

12. The apparatus as recited in claim 2 wherein the second component is vehicle component including an aperture, and the integrated attachment feature is inserted into the aperture of the vehicle component to attach the service valve to the vehicle component.

13. The apparatus as recited in claim 12 wherein the integrated attachment feature is a barbed attachment feature comprising a central boss, a plurality of barbs extending circumferentially around the central boss, and a stop ring extending circumferentially around the central boss.

14. The apparatus as recited in claim 13 wherein the central boss is located in the aperture of the vehicle component when the service valve is attached to the vehicle component, and the plurality of barbs are located on a first side of the vehicle component and the stop ring is located on an opposing second side of the vehicle component.

15. The apparatus as recited in claim 13 wherein the plurality of barbs are in a flexed position when the barbed attachment feature is inserted into the aperture of the vehicle component and the plurality of barbs are in a non-flexed position after the barbed attachment feature is inserted into the aperture of the vehicle component.

16. The apparatus as recited in claim 15 the barbed attachment feature has a non-flexed diameter when the plurality of barbs are in the non-flexed position and a flexed diameter when the plurality of barbs are in the flexed position and the aperture has an aperture diameter, and the non-flexed diameter is greater than the aperture diameter.

17. The apparatus as recited in claim 1 wherein the integrated attachment feature of the molded ring is a projection having an aperture.

18. The apparatus as recited in claim 17 wherein the second component includes a barbed attachment feature having a plurality of barbs extending circumferentially around a central boss, and the barbed attachment feature of the second component is insertable in the aperture of the projection of the integrated attachment feature of the molded ring to secure the first component to the second component.

19. The apparatus as recited in claim 18 wherein the plurality of barbs are in a flexed position when the barbed attachment feature is inserted into the aperture and the plurality of barbs are in a non-flexed position after the barbed attachment feature is inserted to the aperture.

20. The apparatus as recited in claim 19 wherein the barbed attachment feature has a non-flexed diameter when in the non-flexed position, a flexed diameter when in the flexed position and the aperture has an aperture diameter, and the non-flexed diameter is greater than the aperture diameter.

21. The apparatus as recited in claim 1 wherein the first component is a pump and the second component is sheet metal.

22. The apparatus as recited in claim 21 wherein the integrated attachment feature is a barbed attachment feature includes a central boss and a plurality of barbs extending circumferentially around the central boss.

23. The apparatus as recited in claim 21 wherein the molded ring and the integrated attachment feature are both made of Nylon 6/6.

24. A vehicle coolant system comprising:
an engine, and a coolant accepts heat from the engine;
a radiator, and the coolant in the radiator rejects heat to a fluid medium;
a service valve including a first tubular portion and a second tubular portion;
a first hose connected to the first tubular portion at a first joint;
a second hose connected to the second tubular portion at a second joint;
a vehicle component including an aperture; and
a molded ring molded circumferentially around the first joint and the second joint, the molded ring including an integrated attachment feature that is inserted in the aperture of the vehicle component to attach the service valve to the vehicle component, wherein the molded ring and the integrated attachment feature are integrated into one piece.

25. The system as recited in claim 24 wherein the molded ring and the integrated attachment feature are both made of Nylon 6/6.

26. The system as recited in claim 24 wherein the integrated attachment feature is a barbed attachment feature including a central boss and plurality of barbs extending circumferentially around the central boss.

27. A method of forming a molded ring comprising the steps of:
positioning a mold around a first component, the mold including a cavity that defines a molded ring and an integrated attachment feature;
injecting a liquid plastic material into the mold; and
cooling and shrinking the liquid plastic material around the first component to form a solid plastic material defining the molded ring and the integrated attachment feature, wherein the molded ring and the integrated attachment feature are integrated into one piece.

28. The method as recited in claim 27 wherein the liquid plastic material is Nylon 6/6.

29. The method as recited in claim 27 wherein the integrated attachment feature is a barbed attachment feature including a central boss and a plurality of barbs extending circumferentially around the central boss.
